(19) United States
(12) Patent Application Publication
(10) Pub. No.: US 2023/0415588 A1
(43) Pub. Date: Dec. 28, 2023

(54) RAPID CHARGING SYSTEM AND METHOD FOR ELECTRICALLY CONNECTING A VEHCILE TO A CHARGING STATION

(71) Applicant: SCHUNK TRANSIT SYSTEMS GMBH, Wettenberg (DE)

(72) Inventors: Patrick Horst, Rabenau (DE); Matthias Domes, Bad Nauheim (DE); Vasily Podgorny, Biebertal (DE); Juri Eva, Wetzlar (DE); Timo Staubach, Herbstein (DE)

(21) Appl. No.: 18/039,080

(22) PCT Filed: Nov. 30, 2020
(86) PCT No.: PCT/EP2020/083944

§ 371 Date: May 26, 2023

(51) Int. Cl. B60L 53/10; B60L 53/16; B60L 53/30

(52) U.S. Cl. CPC B60L 53/11; B60L 53/30; B60L 53/16

(57) ABSTRACT

The invention relates to a fast charging system for electrically driven vehicles, in particular electric busses or the like, and to a method for forming an electroconductive connection between a vehicle and a stationary charging station by means of a contact device, a charging contact device (10) and a positioning device, the contact device or the charging contact device being disposed on a vehicle, the charging contact device being electrically connectable to the contact device in a contact position, the contact device being positioned in a longitudinal and/or transverse direction with respect to the charging contact device and being moved to the contact position by means of the positioning device, the charging contact device having a charging-contact-element carrier (12) comprising charging contact elements (13), the charging-contact-element carrier being formed as a longitudinal rail disposed in a moving direction of the vehicle, the charging contact elements each forming a strip-shaped charging contact surface, the contact device having a contact element carrier comprising contact elements, the contact elements each forming a contact surface which is smaller than the charging contact surface, the contact elements being electrically connectable to the charging contact elements for forming respective contact pairs in the contact position, the charging contact device having a heating device (35) by means of which the temperature of the charging contact elements is controllable.

The invention relates to a fast charging system for electrically driven vehicles, in particular electric busses or the like, and to a method for forming an electroconductive connection between a vehicle and a stationary charging station by means of a contact device, a charging contact device and a positioning device, the contact device or the charging contact device being disposed on a vehicle, the charging contact device being electrically connectable to the contact device in a contact position, the contact device being positioned in a longitudinal and/or transverse direction with respect to the charging contact device and being moved to the contact position by means of the positioning device, the charging contact device having a charging-contact-element carrier comprising charging contact elements, the charging-contact-element carrier being formed as a longitudinal rail disposed in a moving direction of the vehicle, the charging contact elements each forming a strip-shaped charging contact surface, the contact device having a contact element carrier comprising contact elements, the contact elements each forming a contact surface which is smaller than the charging contact surface, the contact elements being electrically connectable to the charging contact element for forming respective contact pairs in the contact position.

Fast charging systems and methods of this kind are known from the state of the art and are typically employed for fast charging electrically driven vehicles at a bus stop or a stopping point. Electrically driven vehicles used for local transport, such as busses, can thus be successively supplied with electrical energy at the bus stops in question.

From DE 10 2015 219 438 A1 and WO 2015/01887 A1, fast charging systems are known in which a roof-shaped charging contact device is electrically connected to a correspondingly designed contact device. The charging contact device has charging contact elements which are realized in the manner of conductor strips and are disposed so as to extend in a moving direction of the vehicle. Contact elements of the contact device are formed like bolts and realize a punctiform contact with the conductor strips when in the contact position. Reaching the contact position accurately becomes possible because the contact device is inserted into the charging contact device in a vertical direction, perpendicular to a moving direction of the vehicle.

With the fast charging systems known from the state of the art, unfavorable conditions may cause electric arcs between a contact element and a charging contact element, even during a charging process. If the electric bus moves during a charging process, for example as a result of passengers getting off and on the bus, a relative shift of the contact element and charging contact can occur. If a contact surface or charging contact surface has a relatively high electrical resistance, electric arcs can occur. Furthermore, if a communication, which can be effected via a signal contact and/or a data line, for example, between the vehicle and the charging station is disrupted, a charging process can be stopped or kept from starting in an intended manner. Experience has shown that effects of this kind occur increasingly in humid weather conditions. In particular creeping currents can also occur which disrupt a charging process and which can facilitate the formation of electric arcs. Electric arcs cause the charging contact elements and the contact elements to wear out comparatively quickly, which, in turn, requires them to be replaced.

Therefore, the object of the present invention is to propose a fast charging system and a method for forming an electroconductive connection between a vehicle and a charging station which allows a cost-effective operation of the vehicle and a safe contact.

This object is attained by a fast charging system having the features of claim 1 and a method having the features of claim 23.

The fast charging system according to the invention for electrically driven vehicles, in particular electric busses or the like, for forming an electroconductive connection between a vehicle and a stationary charging station, comprises a contact device, a charging contact device and a positioning device, the contact device or the charging contact device being disposed on a vehicle, the charging contact device being electrically connectable to the contact device in a contact position, the contact device being positioned in a longitudinal and/or transverse direction with respect to the charging contact device and being moved to the contact position by means of the positioning device, the charging contact device having a charging-contact-element carrier comprising charging contact elements, the charging-contact-element carrier being formed as a longitudinal rail disposed in a moving direction of the vehicle, the charging contact elements each forming a strip-shaped charging contact surface, the contact device having a contact element carrier comprising contact elements, the contact elements each forming a contact surface which is smaller than the charging contact surface, the contact elements being electrically connectable to the charging contact elements for forming respective contact pairs in the contact position, the charging contact device having a heating device by means of which the temperature of the charging contact elements is controllable.

Thus, the fast charging system according to the invention has charging contact elements formed as conductor strips which are disposed parallel to each other and in the direction of a longitudinal axis of the charging-contact-element carrier. Since the charging contact device has a heating device, it is possible to control the temperature of and/or to heat the charging contact elements by means of the heating device. It is intended that the temperature of only the charging contact elements can be controlled via the heating device. Heating the other components of the charging contact device is not necessary and would result in a comparatively higher energy expenditure. Frost, ice, snow, or the like can be prevented from depositing on the charging contact device and/or directly on the charging contact elements because the temperature of the charging contact elements can be controlled by means of the heating device. Evaporation of water or humidity on the charging contact elements is also facilitated. Experience has shown that, under certain weather conditions, electric arcs and a safe contact without interrupting a charging process can be ensured in this manner.

The positioning device can have a pantograph or a rocker by means of which the contact unit carrier is positionable in at least a vertical direction to the charging contact unit, the contact device being disposed on a vehicle or a charging station. In the case of a rocker, an additional linkage can be provided which stabilizes the contact unit carrier relative to a charging contact device and/or positions it in the respective direction. A pantograph or a rocker and/or a corresponding mechanical drive can be produced particularly simply and cost-effectively. Additionally, the positioning device can also have a transverse guide by means of which the contact unit carrier can be positioned transversely relative to the charging contact device or to a moving direction of the vehicle. The transverse guide can be disposed on a vehicle or a pantograph or a rocker of the positioning device. In both cases, the positioning device and/or a contact unit carrier disposed on the positioning device is displaceable transversely to the moving direction of the vehicle. This displaceability allows the compensation of a wrong positioning of the vehicle at a bus stop transverse to the direction of travel, for example. Moreover, possible vehicle movements due to a one-sided lowering of the vehicle for people entering and exiting the vehicle can be compensated in such a manner that the contact unit carrier cannot become displaced in the transverse direction relative to the charging contact device. For example, the contact device can be disposed on a vehicle roof such that the contact unit carrier can be moved starting from the vehicle roof to the charging contact device and back by means of the positioning device. Alternatively, the contact device can be disposed on the charging station, the contact unit carrier then being moved from a carrier, such as a pole or a bridge, at a bus stop toward a vehicle roof having a charging contact device and back.

The heating device can have an electric heating element which is disposed on the charging contact element. The electric heating element can be a resistance heating element, for example. The heating element can have an electrical insulation and be disposed directly on the charging contact element or abut on it directly. Thus, a comparatively small amount of electric energy is required for heating the charging contact element and it is always ensured that the charging contact element is heated quickly and effectively.

A heating element can be disposed on each charging contact element, the heating element preferably extending over an entire length of the charging contact element. Since the charging contact device has a plurality of charging contact elements, each charging contact element can be heated by one heating element. The respective heating elements can be adjusted to the respective design of the charging contact elements. If the heating element extends over an entire length of the charging contact element, its temperature can also be controlled over its entire length.

The heating element can be a heat conductor which abuts on a rear side of the charging contact element facing away from the charging contact surface. The heat conductor can be formed in the manner of a conductor having an essentially circular or even strap-shaped cross section. Since the heat conductor directly abuts on the rear side of the charging contact element, the heat conductor is protected from environmental impacts and simultaneously effects a direct heating of the charging contact element.

The heating element can be designed for low voltage operation, preferably 230 V alternating current or 24 V direct current. Since this low voltage is common and also regularly provided at charging stations, no special voltage transformation is required for operating the heating element. The heating element can even be switched on and off by means of a simple switch element, for example. In this manner, the heating device can be formed particularly simply.

The charging contact element can be formed by a metal strip. The metal strip can have a comparatively flat cross section. The metal strip can form a conductor strip which can be disposed in the longitudinal direction and/or a horizontal direction, which essentially corresponds to a moving direction of the vehicle. For example, the charging contact elements can be over one meter long, such that a vehicle can stop within an area at a bus stop. Thus, the charging contact elements can form a comparatively large contactable surface for the contact elements. A metal strip can also be easily produced, for example by using a semi-finished product as a charging contact element.

The metal strip can be mounted on the charging-contact-element carrier by means of a screwed connection, thread bolts being disposed on the metal strip and passing through the passage openings in the charging-contact-element carrier. By mounting the metal strip on a body of the charging-contact-element carrier by means of a screwed connection, the charging contact elements can be replaced particularly simply when they are damaged, for example. The metal strip can be made of copper, aluminum or a comparable alloy. The thread bolts can be screwed into the metal strip or be attached by means of butt welding. Passage openings through which the thread bolts are guided can be formed in the body of the charging-contact-element carrier. The charging contact elements or the metal strip can simply be screwed to the body by means of nuts on the thread bolts in a simple manner. In principle, using screws for fastening the metal strips on the body is also possible. Advantageously, the metal strip can thus be attached without an adhesive which significantly facilitates replacing it.

Opposite ends of the metal strip can run transversely to the charging contact surface and pass through passage openings in the charging-contact-element carrier, at least one end being connected to a cable of the charging station. Thus, the ends can be bent, for example so as to extend orthogonally relative to the charging contact surface orthogonal. When mounting the charging contact element, the ends can be inserted into a body of the charging-contact-element carrier through passage openings and be guided through it in this manner. A cable of the charging station can be directly connected to at least one end, said cable then connecting the charging contact element directly to the charging station or a power source.

The charging contact elements can each be inserted into one receiving groove, which is formed in the charging-contact-element carrier, the charging contact surfaces then being flush with a surface of the charging-contact-element carrier facing the contact element carrier. The surface of the charging-contact-element carrier is at least partially formed without significant interruptions such that contact elements can glide along the surface. The receiving groove has a depth and width which essentially correspond to a height and width of the charging contact element, relative to a cross section.

A groove into which the heating element can be inserted can be formed in a bottom of the receiving groove. The groove formed in the bottom of the receiving groove can be narrower than the groove itself such that the charging contact element abuts on the bottom of the receiving groove and is thus safely positioned relative to the surface of the charging-contact-element carrier. The groove can be designed such that the heating element is positioned in it and essentially fills out the groove. It can thus be ensured that the heating element abuts on the charging contact element as tightly as possible. Furthermore, the heating element can thus be mounted particularly simply.

The groove can run parallel, meander-shaped and/or spiral-shaped relative to a longitudinal axis of the charging contact element. If the heating element is particularly thin, a large contact surface can be formed between the heating element and the charging contact element.

A notch can be formed between two charging contact elements in a surface of the charging-contact-element carrier facing the contact element carrier. The notch can be formed in the manner of a groove and run parallel to longitudinal axes of the charging contact elements. The notch can increase the surface of the charging-contact-element carrier between the charging contact elements such that unintended creeping currents between charging contact elements can effectively be prevented from forming. In particular a coherent water film or a water net can be prevented from forming on the surface. It is also possible that two or more notches of this kind are formed between two charging contact elements. Furthermore, multiple notches can be formed between all charging contact elements in each case.

The charging-contact-element carrier can have a body which is made of a dielectric plastic material or a composite material and which is preferably formed in one piece. In this case, the body can be produced particularly simply, stably and cost-effectively. Since the body is made of a dielectric material, the charging contact elements and, if applicable, their mounting elements do not require a special electrical insulation. In this case, the body is also weather-resistant and cannot corrode. The body can be made of fiberglass-reinforced plastic, for example, and thus be easily produced in large quantities.

The contact device can be disposed on a vehicle roof and the charging contact device can be disposed on a stationary charging station or vice versa. This can be a vehicle roof of an electric bus or a tram. For example, in this case, the contact device or the charging contact device can also be positioned such on the vehicle roof that it is disposed on the driver's side of the vehicle roof in the direction of travel. Positioning the contact device and/or charging contact device is thus significantly facilitated for the driver of the vehicle since said devices and/or their position are within the driver's line of sight.

The heating device can comprise a temperature control and a thermostat, which can abut on a charging contact element. The temperature control can be used to control when the heating device is switched on and off. The heat output of the heating device can also be controlled. The thermostat can measure a temperature on at least one charging contact element. All charging contact elements can be contacted and controlled individually, i.e., using one thermostat each. It is also possible to provide only one thermostat and to control the temperature of all charging contact elements according to this thermostat.

The heating device can be configured to heat the charging contact elements at a temperature of ≤5° C. In this way, it can be ensured at all times that the charging contact elements do not freeze over. Charging contact elements covered with frost or ice favor the formation of electric arcs during a charging process. Furthermore, the heating of the charging contact elements can be designed to switch off at ≥15° C. A thermostat which has different switching points and/or which can trigger a respective switching process for different temperatures can also be used.

A length of the charging-contact-element carrier can be shorter than a vehicle length. Thus, the charging-contact-element carrier, which is formed in the manner of a longitudinal rail and extends in a moving direction of the vehicle, is not required to protrude beyond the vehicle at its ends. The charging-contact-element carrier can thus be designed so as to be comparatively short, whereby a production becomes cost-effective and it can also be easily mounted on a pole of a charging station, or, alternatively, a vehicle roof.

The power contacts or the corresponding contact elements are designed to transmit a current of 500 Ampere to 1000 Ampere at a voltage of at least 750 V to 1000 V. For example, a power of 375 kW to 750 kW, to preferably 600 kW, can be transmitted via the charging contact unit. In this case, it can be sufficient to only provide one connection line for connection to the charging contact element. The vehicle can also be charged faster because higher currents can be transmitted in less time.

The charging contact surfaces and/or contact surfaces can be disposed relative to each other in the transverse direction or longitudinal direction such that first, the protective-ground contact; second, the power contacts; and lastly, the signal contact can be formed. By means of this arrangement of the charging contact surface relative to the assigned contact surfaces in the longitudinal direction of the strip-shaped charging contact surfaces, a defined order for forming and disconnecting contact pairs with respect to the longitudinal direction can be realized. In this case, “longitudinal direction” means the direction in which the strip-shaped charging contact surface essentially extend. Since this can be a moving direction of a vehicle, the longitudinal direction essentially corresponds to a horizontal direction if the charging-contact-element carrier is positioned horizontally. The charging-contact-element carrier can also be positioned parallel to a road of a vehicle; the road can also be inclined relative to the horizontal. “Transverse direction” means a vertical direction which extends transversely and/or orthogonally relative to the strip-shaped charging contact surfaces. When the contact device and the charging contact device are guided together in the vertical and/or horizontal direction, a first contact pair can be formed initially before another contact pair, according to the defined order for forming the contact pairs.

The contact elements can form a punctiform contact surface. The contact elements can be bolt-shaped. Furthermore, the contact elements can be elastically mounted on the contact element carrier. The contact elements can be produced particularly simple in this case, said contact elements being elastically mounted using a simple compression spring within or on the contact element. As a result, a point contact with a charging contact element can be established under spring pre-load. Furthermore, a plurality of contact elements, that means several contact pairs, can be provided for a contact pair for a power contact, for example. Preferably, two contact elements can be provided for each phase or each power contact. In principle, it is also possible to form other shapes of contact surfaces, depending on the form of the contact elements. It is essential, however, that the respective contact surface is always smaller than the smallest charging contact surface and/or than the charging contact surface shortest in the longitudinal direction.

The charging-contact-element carrier can form a receiving opening for the contact element carrier, the contact element carrier being insertable into the receiving openings of the charging-contact-element carrier, or the contact element carrier can form a receiving opening for the charging-contact-element carrier, the charging-contact-element carrier being insertable into the receiving opening of the contact-element carrier, the receiving opening forming a guide for the contact element carrier or the charging-contact-element carrier when guiding together the contact element carrier and charging-contact-element carrier. In this case, the receiving opening can preferably be V-shaped. In the event of a relative deviation of the contact-element carrier when guiding together the contact device and the charging contact device towards the receiving opening, the V-shape of the receiving opening causes a centering of the contact-element carrier and/or of the charging-contact-element carrier. Vice versa, the contact element carrier can form a receiving opening for the charging-contact-element carrier, the charging-contact-element carrier then being insertable into the receiving opening of the contact-element carrier. Preferably, the receiving opening can also have a V-shape in this case, the contact elements being disposed within the V-shaped receiving opening. Possible deviations in the position of the vehicle from an intended stopping position during a stop at a bus stop can be offset easily by guiding the contact-element carrier and/or the charging-contact-element carrier into contact position by means of the receiving opening. The charging-contact-element carrier can be a roof-shaped longitudinal rail which is disposed in a moving direction of the vehicle. In this case, the charging contact elements can be disposed on a lower side of the roof-shaped longitudinal rail such that the charging contact elements are not directly subject to weather effects. Additionally, the roof-shaped longitudinal rail can preferably be formed so as to be open at its ends, such that the contact element carrier can also be inserted in and/or removed from the roof-shaped longitudinal rail in the direction of travel. If the charging-contact-element carrier is to be disposed on a vehicle, the charging-contact-element carrier can be formed as a web-shaped elevation which is disposed in a moving direction of the vehicle.

In the method according to the invention for forming an electroconductive connection between a vehicle and a stationary charging station, in particular for a fast charging system for electrically driven vehicles, such as electric busses or the like, the fast charging system comprises a contact device, a charging contact device and a positioning device, the charging contact device being electrically connected to the contact device in a contact position, the contact device being positioned in a longitudinal and/or transverse direction with respect to the charging contact device and being moved to the contact position by means of the positioning device, the charging contact device having a charging-contact-element carrier comprising charging contact elements, the charging-contact-element carrier being formed as a longitudinal rail disposed in a moving direction of the vehicle, the charging contact elements each forming a strip-shaped charging contact surface, the contact device having a contact element carrier comprising contact elements, the contact elements each forming a contact surface which is smaller than the charging contact surface, the contact elements being electrically connected to the charging contact elements for forming respective contact pairs in the contact position, the temperature of the charging contact elements being controlled by means of a heating device of the charging contact device. For further details on the advantageous effects of the method according to the invention, reference is made to the description of advantages of the fast charging system according to the invention. Further advantageous embodiments of the method are apparent from the respective dependent claims referring back to claim 1.

Hereinafter, preferred embodiments of the invention will be described in more detail with reference to the accompanying drawings.

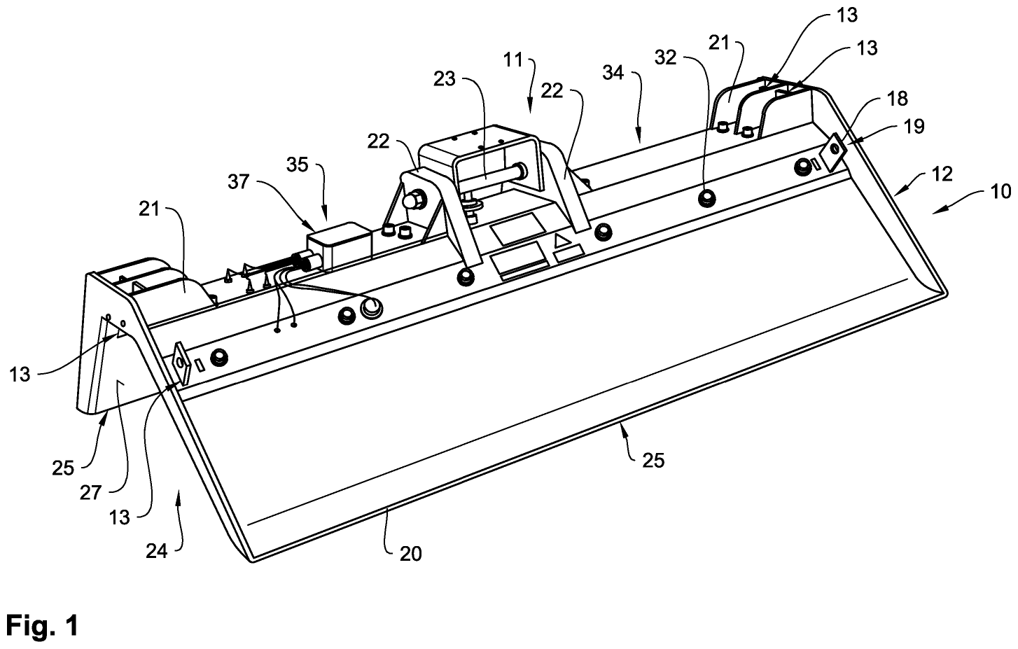

FIG. 1 is a perspective view of a charging contact device of a fast charging system;

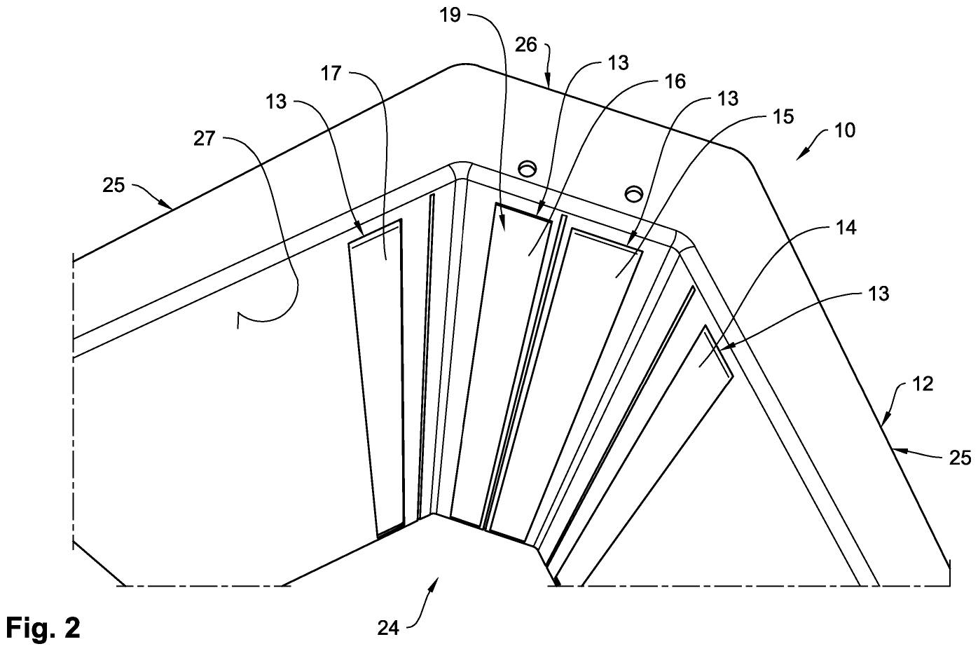

FIG. 2 is a perspective bottom view of the charging contact device;

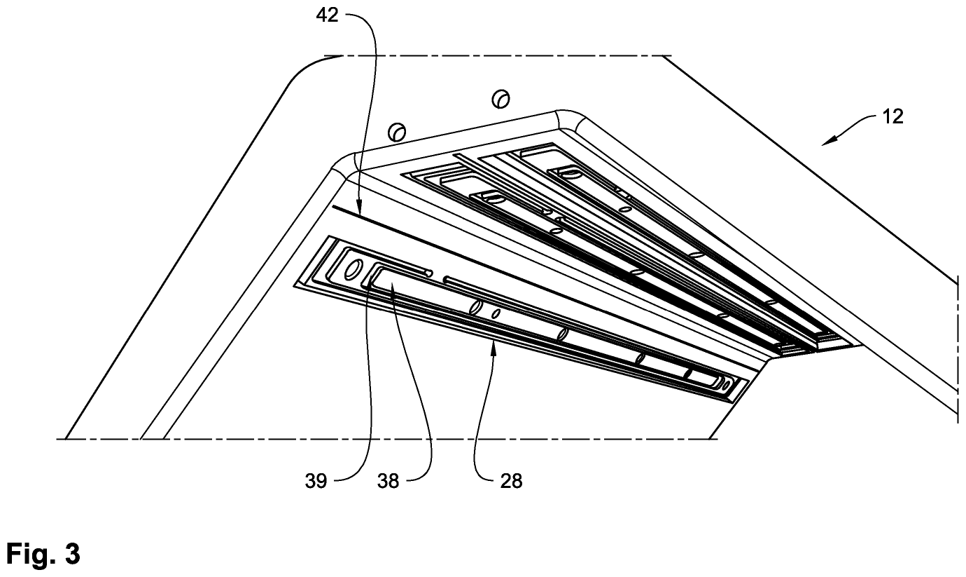

FIG. 3 is a perspective bottom view of a charging-contact-element carrier of the charging contact device;

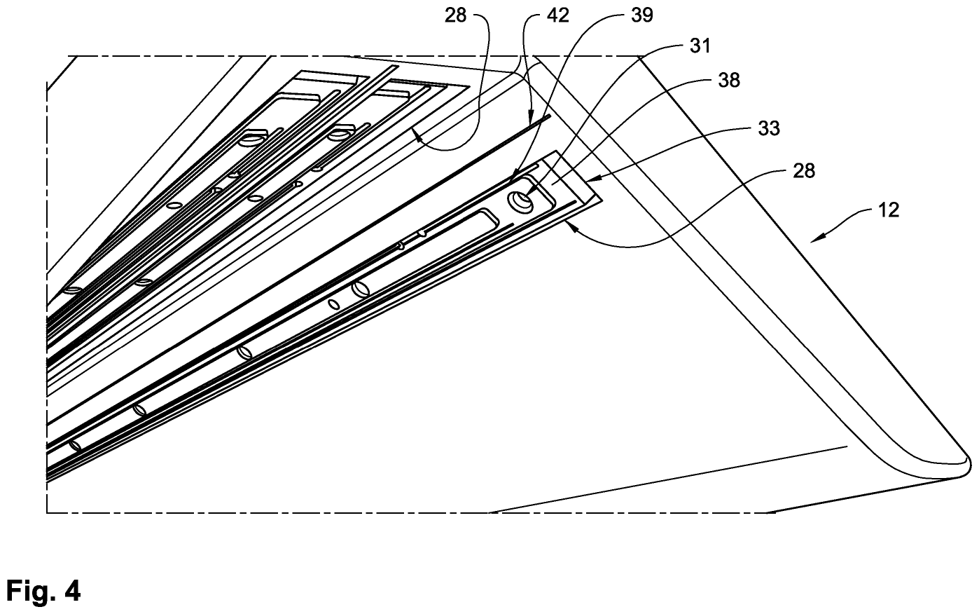

FIG. 4 is another perspective bottom view of the charging-contact-element carrier of the charging contact device;

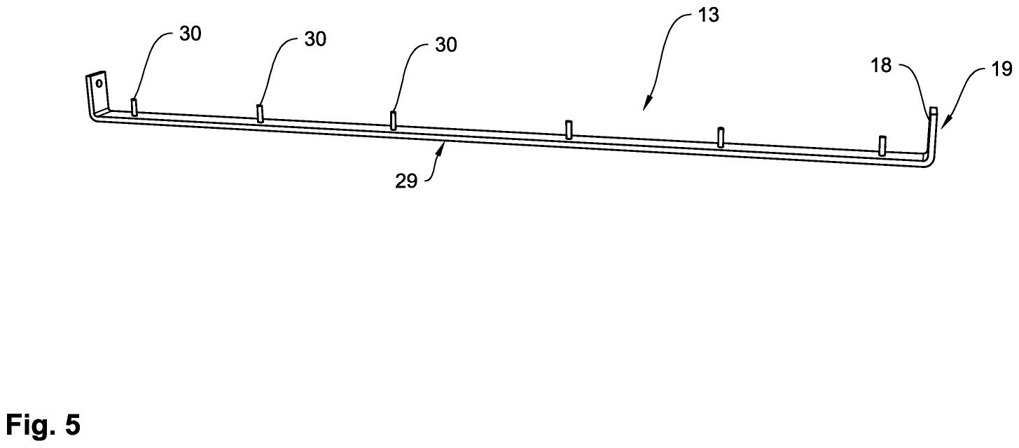

FIG. 5 is a perspective view of a charging contact element;

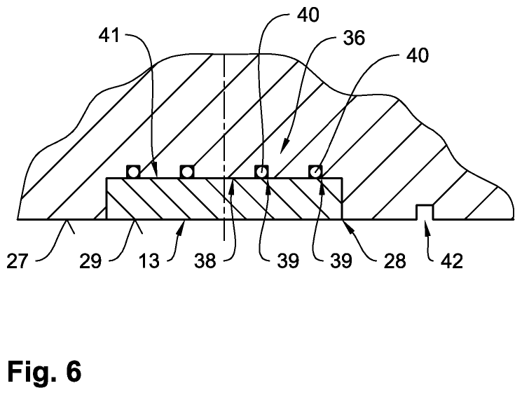

FIG. 6 is a partial sectional view of the charging contact device.

FIGS. 1 and 2 show a charging contact device 10 of a fast charging system (not shown) for electrically driven vehicles, in particular electric busses or the like, charging contact device 10 being designed to be connected to a contact device (not shown). Charging contact device 10 is roof-shaped and can be mounted on a pole (not shown) over a vehicle above a road by means of a mounting device 11. For better illustration, an upper cover of charging contact device 10 is not shown. A vehicle which is positioned below charging contact device 10 can have the contact device which can be disposed on the underside of charging contact device 10 by means of a positioning device (not shown).

Charging contact device 10 is essentially formed by a charging-contact-element carrier 12 made of plastic material, in particular fiberglass-reinforced plastic, and by charging contact elements 13. Charging contact elements 13 themselves are each formed as metal strips 14, 15, 16 and 17 and extend in the longitudinal direction of charging-contact-element carrier 12. Metal strips 14 and 17 serve to transmit a charging current, metal strip 15 representing a protective-ground conductor and metal strip 16 representing a control line. Contact tracks 18 on respective bent ends 19 of metal strips 14 and 17 serve for the connection to electric lines (not shown). Charging-contact-element carrier 12 is essentially formed by a body 20 which is formed by one piece and has reinforcement ribs 21 and attachment ribs 22 having a bolt 23 for the suspension of charging-contact-element carrier 12 on a pole or the like. A receiving opening 24 of charging contact device 10 for receiving the contact device is V-shaped in such a manner that two symmetrical legs 25 are connected to each other via a horizontal web 26. Within receiving opening 24, the charging contact device or the charging-contact-element carrier 12 having the charging contact elements 13 forms a surface 27 for the contact device to abut on the contact elements (not shown).

As can be seen from FIGS. 3 and 4, respective receiving groves 28 are formed for the charging contact elements 13 or the metal strips 14 to 17. Charging contact elements 13 form strip-shaped charging contact surfaces 29 within receiving opening 24.

FIG. 5 shows an individual charging contact element 13 on which thread bolts 30 are attached by means of butt welding. Thread bolts 30 are inserted through passage openings 31 in charging-contact-element carrier 12 and are screwed to charging-contact-element carrier 12 by means of nuts 32. Furthermore, slit-shaped passage openings 33 through which ends 19 are inserted are formed in charging-contact-element carrier 12. Charging contact elements 13 can conveniently be attached and connected to an upper surface 34 of charging-contact-element carrier 12.

Furthermore, charging contact device 10 comprises a heating device 36 which is formed by heating elements 36 on each charging-contact-element carrier 12 and a temperature control 37 having a thermostat (not shown). A combined view of FIGS. 3, 4 and 6 shows that in a bottom 38 of respective receiving grooves 28, grooves 39 are formed in which a heat conductor 40 is inserted, said heat conductor 40 forming heating element 36. Heat conductor 40 abuts on a rear side 41 of charging contact element 13 and thus allows respective charging contact elements 13 to be temperature-controlled and/or heated effectively.

Furthermore, a notch 42 is formed between two charging contact elements 13 in surface 27 of charging-contact-element carrier 12. Notch 42 runs parallel to a length of charging contact elements 13. The notch makes it considerably more difficult for creeping currents to form between charging contact elements 13.

1. A fast charging system for electrically driven vehicles for forming an electroconductive connection between a vehicle and a stationary charging station, comprises a contact device, a charging contact device (10) and a positioning device, the contact device or the charging contact device being disposed on a vehicle, the charging contact device being electrically connectable to the contact device in a contact position, the contact device being positioned in a longitudinal and/or transverse direction with respect to the charging contact device and being moved to the contact position by means of the positioning device, the charging contact device having a charging-contact-element carrier (12) comprising charging contact elements (13), the charging-contact-element carrier being formed as a longitudinal rail disposed in a moving direction of the vehicle, the charging contact elements each forming a strip-shaped charging contact surface (29), the contact device having a contact element carrier comprising contact elements, the contact elements each forming a contact surface which is smaller than the charging contact surface, the contact elements being electrically connectable to the charging contact elements for forming respective contact pairs in the contact position, wherein the charging contact device has a heating device (35) by means of which the temperature of the charging contact elements is controllable.

2. The fast charging system according to claim 1, wherein the heating device (35) has an electric heating element (36) which is disposed on the charging contact element (13).

3. The fast charging system according to claim 2, wherein a heating element (36) is disposed on each charging contact element (13), the heating element extending over an entire length of the charging contact element.

4. The fast charging system according to claim 2, wherein the heating element (36) is a heat conductor (40) which abuts on a rear side (41) of the charging contact element facing away from the charging contact surface (29).

5. The fast charging system according to claim 2, wherein the heating element (36) is designed for low voltage operation.

6. The fast charging system according to claim 1, wherein the charging contact element (13) is formed by a metal strip (14, 15, 16, 17).

7. The fast charging system according to claim 6, wherein the metal strip (14, 15, 16, 17) is mounted on the charging-contact-element carrier (12) by means of a screwed connection, thread bolts (30) being disposed on the metal strip and passing through the passage openings (31) in the charging-contact-element carrier.

8. The fast charging system according to claim 6, wherein opposite ends (19) of each metal strip (14, 15, 16, 17) run transversely to the charging contact surface (29) and pass through passage openings (33) in the charging-contact-element carrier (12), at least one end being connected to a cable of the charging station.

9. The fast charging system according to claim 1, wherein the charging contact elements (13) are each inserted into one receiving groove (28), which is formed in the charging-contact-element carrier (12), in such a manner that the charging contact surfaces (29) are flush with a surface (27) of the charging-contact-element carrier facing the contact element carrier.

10. The fast charging system according to claim 9, wherein a groove (39) into which the heating element (36) is inserted is formed in a bottom (38) of the receiving groove (28).

11. The fast charging system according to claim 10, wherein the groove (39) runs parallel, meander-shaped or spiral-shaped relative to a longitudinal axis of the charging contact element (13).

12. The fast charging system according to claim 1, wherein a notch (42) is formed between two charging contact elements (13) in a surface (27) of the charging-contact-element carrier (12) facing the contact element carrier.

13. The fast charging system according to claim 1, wherein the charging-contact-element carrier (12) has a body (20) which is made of a dielectric plastic material or a composite material and which is formed in one piece.

14. The fast charging system according to claim 1, wherein the contact device is disposed on a vehicle roof and the charging contact device (10) is disposed on a stationary charging station or vice versa.

15. The fast charging system according to claim 1, wherein the heating device (35) comprises a temperature control (37) and a thermostat, which abuts on a charging contact element (13).

16. The fast charging system according to claim 1, wherein heating device (35) is configured to heat the charging contact elements (13) at a temperature of ≤5° C.

17. The fast charging system according to claim 1, wherein a length of the charging-contact-element carriers (12) is shorter than a vehicle length.

18. The fast charging system according to claim 1, wherein the contact pairs are configured to establish power contacts, a signal contact and a protective-ground contact of the fast charging system, respectively.

19. The fast charging system according to claim 18, wherein the power contacts are designed to transmit a current of 500 to 100 A at a voltage of at least 750 to 1.000 V.

20. The fast charging system according to claim 18, wherein the charging contact surfaces (29) or the contact surfaces are disposed relative to each other in the transverse direction or longitudinal direction such that first, the protective-ground contact; second, the power contacts; and lastly, the signal contact is/are formed.

21. The fast charging system according to claim 1, wherein the contact elements form a punctiform contact surface.

22. The fast charging system according to claim 1, wherein the charging-contact-element carrier (12) forms a receiving opening (24) for the contact element carrier, the contact element carrier being insertable into the receiving opening of the charging-contact-element carrier or the contact element carrier forming a receiving opening for the charging-contact-element carrier, the charging-contact-element carrier being insertable into the receiving opening of the contact-element carrier, the receiving opening forming a guide for the contact element carrier or the charging-contact-element carrier when guiding together the contact element carrier and charging-contact-element carrier.

23. A method for forming an electroconductive connection between a vehicle and a stationary charging station for a fast charging system for electrically driven vehicles, by means of a contact device, a charging contact device (10) and a positioning device, the charging contact device being electrically connected to the contact device in a contact position, the contact device being positioned in a longitudinal and/or transverse direction with respect to the charging contact device and being moved to the contact position by means of the positioning device, the charging contact device having a charging-contact-element carrier (12) comprising charging contact elements (13), the charging-contact-element carrier being formed as a longitudinal rail disposed in a moving direction of the vehicle, the charging contact elements each forming a strip-shaped charging contact surface (29), the contact device having a contact element carrier comprising contact elements, the contact elements each forming a contact surface which is smaller than the charging contact surface, the contact elements being electrically connected to the charging contact elements for forming respective contact pairs in the contact position, characterized in that, the temperature of the charging contact elements is controlled by means of a heating device (35) of the charging contact device.
